(19) United States
(12) Patent Application Publication
(10) Pub. No.: US 2007/0143232 A1
(43) Pub. Date: Jun. 21, 2007

(54) Mail markings with key encoding

(75) Inventors: Judith D. Auslander, Westport, CT (US); Steven M. Kaye, Weston, CT (US); Michael P. Swenson, Danbury, CT (US)

Correspondence Address: PITNEY BOWES INC.;35 WATERVIEW DRIVE, P.O. BOX 3000, MSC 26-22, SHELTON, CT, 06484-8000, US

(73) Assignee: Pitney Bowes Incorporated, Stamford, CT (US)

(21) Appl. No.: 11/311,742

(22) Filed: Dec. 19, 2005

(51) Int. Cl. G06F 17/00

(52) U.S. Cl. 705/408

(57) ABSTRACT

A mail piece marking for a mail piece including a first section printed with a first ink; and a second section printed with a second different ink. The first and second sections include a substantially same color in normal daylight. The first and second sections are intermixed such that combined reading of the first and second sections conveys a first mail piece marking information. The second ink is adapted to be machine readable to read a second different mail piece marking information contained in the second section.

### BACKGROUND OF THE INVENTION

1. Field of the Invention

The present invention relates to printing an indicium or marking and, more particularly, to an indicium or marking with a hidden key for subsequent processing of an article, such as a mail piece.

2. Brief Description of Prior Developments

Printing indicium, such as linear or 2D bar codes or mail piece indicium, with one ink limits the information capacity of the indicium and also does not allow embedding of covert information. Printing of postage indicium with a color luminescent ink, such as a fluorescent ink or a phosphorescent ink, is described in U.S. patent application Ser. No. 10/692,569 filed Oct. 24, 2003, which is hereby incorporated by reference in its entirety. Dark color fluorescent inks (e.g., dual luminescent) are described in U.S. patent application publication Nos. US 2002/0195586 A1, US 2003/0005303 A1, and US 2003/0041774 A1, which are hereby incorporated by reference in their entireties. U.S. patent application Ser. No. 10/692,570, which is hereby incorporated by reference in its entirety, describes halftone printing and gray scale printing with multi-signal transmission ink. U.S. Pat. No. 5,153,418 discloses multiple resolution machine readable symbols.

Barcodes are used in many applications for the identification, tracking, and tracing of objects, letters, or packages. Some applications require only very basic information about an object (identity or destination) while other applications require detailed information about an object (e.g. postage paid, origin address, postage meter number, sender, addressee, destination address, weight, date, contents, batch number). Barcodes are also used extensively for the identification of objects for sale; for example the Universal Product Code (UPC), and in many other applications. Such barcodes could, in principle, be expanded to include data about batch numbers, production dates, or expiration dates to aid in product recalls and rotation of product inventory.

Introduction of additional indicium information can be hindered by several factors including: real estate available on the object for bar coding; existing standardized barcode specification precluding expansion (e.g., PostNet is set as 12 digits); resolution of existing barcode readers and printers; expense and logistics to retrofit existing readers and printers; need for barcoding schemes to conform to the least common denominator user.

Currently the solution for adding additional information in an indicium is to retain the old scheme (e.g., PostNet barcode) for a period of time longer than desired. When the need becomes acute, then new schemes (for instance PLANET and Universal Postal Union (UPU)/Remote Video Encoding (RVE) barcode supplementary barcodes) can be added to the same object, such as an envelope. This approach is especially unsatisfactory because it drives the adoption of independent/non-integrated indicium rather than driving the adoption of coordinated/integrated indicium solutions with a clear upward migration path. In the retail market place, the problems associated with expansion of barcodes and introduction of new barcode reader standards have precluded the use of these barcodes to aid in the Universal Product Code (UPC) tracking of expiration dates or product batch numbers.

### SUMMARY OF THE INVENTION

In accordance with one aspect of the present invention, a mail piece indicium for a mail piece is provided including a first section printed with a first ink; and a second section printed with a second different ink. The first and second sections include a substantially same color in normal daylight. The first and second sections are intermixed such that combined reading of the first and second sections conveys a first mail piece indicium information. The second ink is adapted to be machine readable to read a second different mail piece indicium information contained in the second section.

In accordance with another aspect of the present invention, a system for processing a mail piece is provided comprising a printer, a reader and a controller. The printer is adapted to print a mail piece indicium on the mail piece. The printer is adapted to print the indicium with a first section printed with a first ink and a second section printed with a second different ink. The first and second inks comprise a substantially same color in normal daylight. The reader is adapted to sense the second ink for reading information printed in the second section of the indicium with the second ink. The controller is adapted to further process the mail piece based upon the information in the second section read by the reader.

In accordance with one method of the present invention, a method of processing a mail piece is provided comprising printing a mail piece indicium on the mail piece, the mail piece indicium comprising first information printed in at least two different ink sections, wherein different respective inks of the at least two sections have a substantially same color in normal daylight, and wherein when exposed to an excitation source a second one of the sections printed with a second one of the inks is separately discernable from a first one of the sections printed with the first one of the inks; reading the second section when exposed to an excitation source to obtain second information contained in the second section; and performing an action on the mail piece based upon the second information read in the second section.

### BRIEF DESCRIPTION OF THE DRAWINGS

The foregoing aspects and other features of the present invention are explained in the following description, taken in connection with the accompanying drawings, wherein:

FIG. 1 is a plan view of a mail piece comprising an indicium incorporating features of the present invention;

FIG. 2 is a block diagram of an example of a printer used to print the indicia shown in FIG. 1;

FIG. 3 is a view of the delivery address of the mail piece of FIG. 1 shown in normal daylight;

FIG. 4 is a view of the delivery address of FIG. 3 showing the characters printed with the first ink;

FIG. 5 is a view of the delivery address of FIG. 3 showing the characters printed with the second ink;

FIG. 6 is a view of characters shown in FIG. 5 exposed to an excitation source and as a negative image;

FIG. 7 is a diagram showing some of the steps which can be used with the present invention;

FIG. 8 is a block diagram showing one example of a device used to read and further process a mail piece having indicium incorporating features of the present invention;

FIG. 9 is a view of a bar code shown in normal daylight printed with two different inks comprising features of the present invention;

FIG. 10 is a view of the bar code of FIG. 9 showing the characters printed with the first ink;

FIG. 11 is a view of the delivery address of FIG. 9 showing the characters printed with the second ink; and

FIG. 12 is a view of a destination address and delivery point bar code showing an example of an organization of how data can be stored in groups of bars in a bar code printed with features of the present invention.

### DETAILED DESCRIPTION OF THE PREFERRED EMBODIMENTS

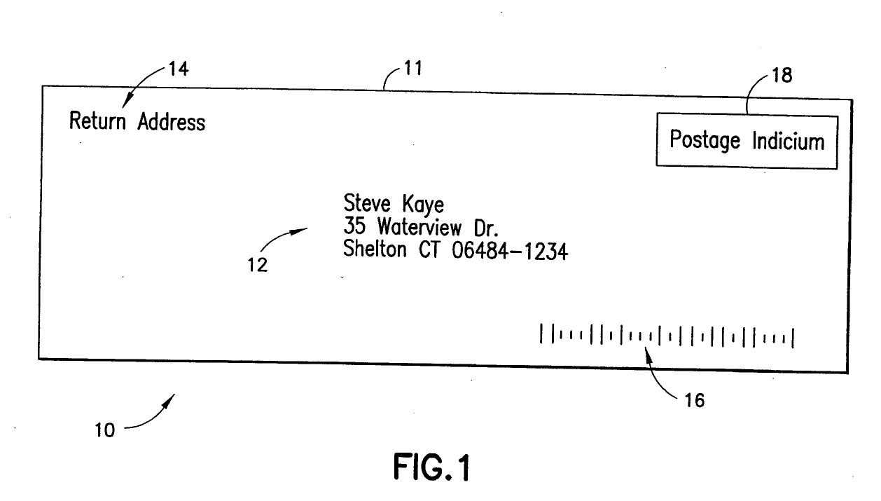

Referring to FIG. 1, there is shown a plan view of a mail piece 10 incorporating features of the present invention. Although the present invention will be described with reference to the exemplary embodiments shown in the drawings, it should be understood that the present invention can be embodied in many alternate forms of embodiments. In addition, any suitable size, shape or type of elements or materials could be used.

The mail piece 10 shown in FIG. 1 comprises an envelope. However, in alternate embodiments, the mail piece could comprise any suitable type of mail piece including a package for example. The mail piece 10 includes the envelope or substrate 11, and three mail piece markings or indicia 12, 14 and 16. However, features of the present invention could be used on a mail piece with more or less than three mail piece indicia. The marking(s) can include any suitable type of markings including a printed marking comprising characters and/or symbols for example. Postage indicium 18 can be applied to the envelope after the mail piece indicium is applied. The postage indicium 18 could be printed directly on the substrate 11, printed on a label which is subsequently attached to the substrate, or could comprise a postage stamp, for example. In the embodiment shown, the mail piece indicium comprises a destination address 12, a return address 14, and a Planet bar code 16. The mail piece indicium could include an address block Postnet bar code for example.

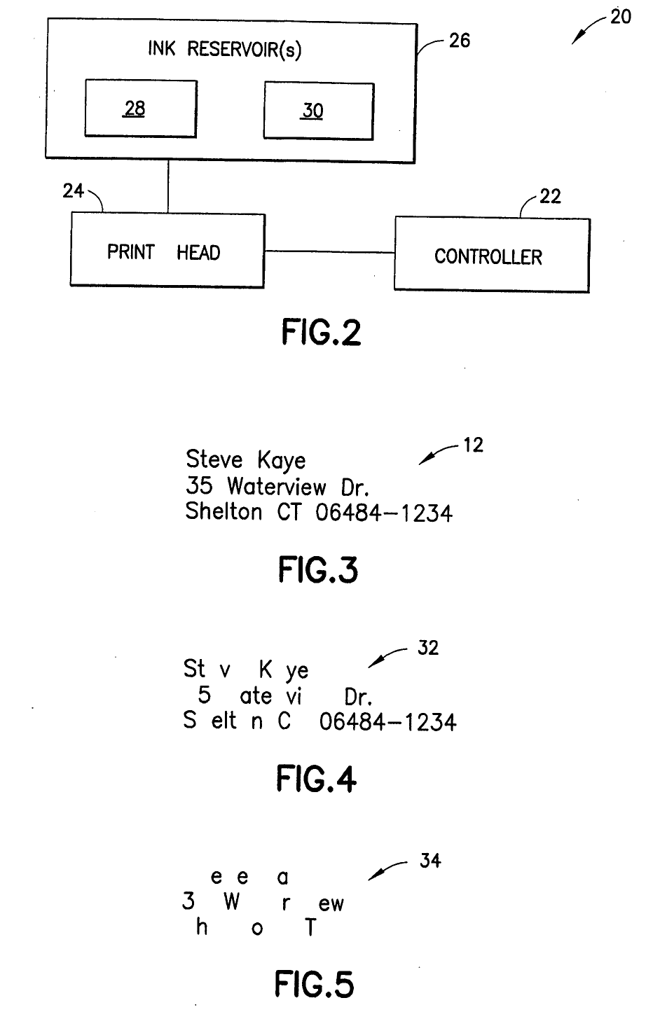

Referring also to FIG. 2, a schematic diagram of a printing device 20 for printing the mail piece indicium 12-16 on the envelope 11 is shown. The printing device could comprise any suitable type of device for printing mail piece indicium on a mail piece substrate, including a mailing label for example. For example, the printing device could comprise a desktop computer with a computer printer, or a dedicated mailing/addressing machine printer. The printing device 20 generally comprises at least one print head 22, a controller 24, and at least one ink reservoir 26. The ink reservoir 26 preferably comprises at least two different inks 28, 30. The controller 22 is adapted to control printing of the inks from the ink reservoir 26 by the print head 24 on the mail piece substrate.

The first ink 28 preferably comprises a normal printer ink, such as a non-luminescent black ink for example. The second ink preferably comprises a color luminescent ink, such as a fluorescent ink or a phosphorescent ink, such as described in U.S. patent application Ser. No. 10/692,569 filed Oct. 24, 2003, U.S. Pat. No. 6,827,769, and U.S. Pat. No. 6,793,723 which are hereby incorporated by reference in their entireties. In a preferred embodiment, the first and second inks have a substantially same color in normal daylight when viewed by a person, such as black for example. Because the second ink is a luminescent ink, it can be excited by a radiation source, such as an Ultraviolet (UV) light, to read the ink separate from other ink(s).

Referring also to FIG. 3, an example of one type of mail piece indicium (the destination address in this example) is shown which has been printed with the printing device 20 shown in FIG. 2 and with both of the inks 28, 30. FIG. 3 shows the mail piece indicium 12 as would be seen in normal daylight by a person. The indicium 12 comprises alphanumeric characters which have substantially the same color and appearance in normal daylight. The first marking or indicium 12 conveys a first information; namely, the destination address in this example. The indicium 12 contains two sections. As seen in FIG. 4, a first section 32 contains predetermined ones of the alphanumeric characters of the indicium 12. This first section 32 is printed with the first ink 28. As seen in FIG. 5, a second section 34 contains other predetermined ones of the alphanumeric characters of the indicium 12. This second section 34 is printed with the second ink 30.

The first and second sections 32, 34 combine to form the indicium 12 and the first information of the indicium which can be read by a person in normal daylight. In alternate embodiments, the indicium could comprise more than two sections, such as when more than two inks are used to print the indicium. In addition, the inks could have different colors in normal daylight, so long as the first information is preferably relatively easily read or discernable by a person in normal daylight.

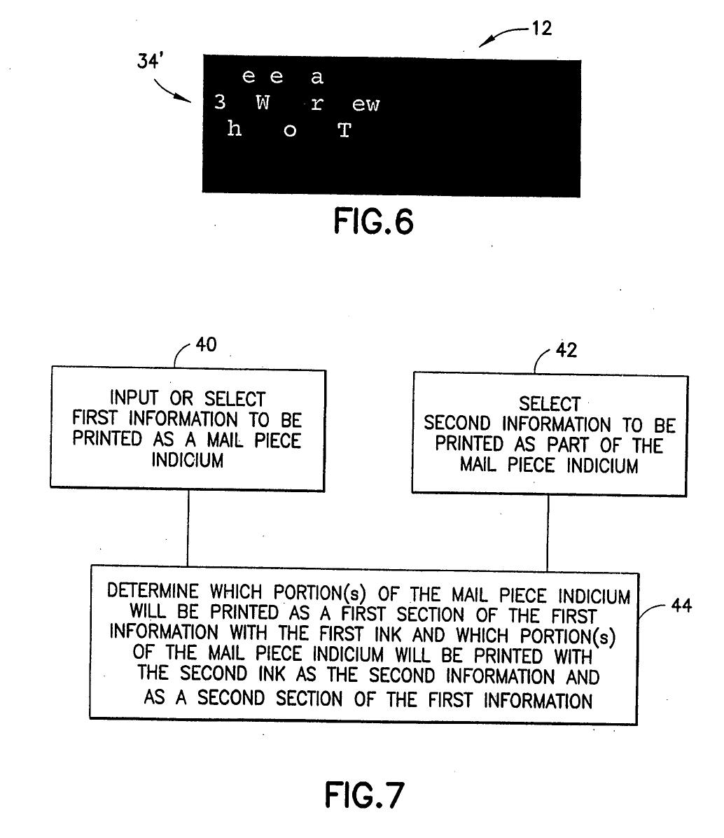

Because the second section 34 is printed with luminescent ink, it can be read separate from the first section 32 when subjected to an excitation source, such as a UV light for example. Referring to FIG. 6, the indicium 12 is shown when subjected to UV light and read as a negative image. As seen, the first section 32 is not read because it is not luminescent. The characters of the second section 34, on the other hand, are clearly viewable as the inverted image 34′. Thus, with the present invention the indicium 12 contain two informations; the first information of the daylight viewable indicium shown in FIG. 3, and the second information shown in FIGS. 5 and 6 which can be read when the indicium is exposed to an excitation source. In an alternate embodiment, such as when the inks used to print the indicium contain multiple luminescent inks which can be excited at different excitation frequencies, more than one second information could be provided.

The present invention gives the possibility of adding information seamlessly to printed indicium by adding an additional ink with a same visual color, but with the potential of being read in a fluorescence mode (ON/OFF) and, therefore, automate the process without introducing other major changes in the reader except using an excitation UV lamp. The present invention could be used on all postage meters and all products related to the USPS intelligent mail. The invention can consist of printing with two or more different inks with the same visual appearance, but one with a hidden signal revealed by UV exposure in order to encode variable information by changing in a predetermined way the location of the inks used to print specific characters, modules, pixels. This can be applied to specific symbologies, OCR, alphanumeric characters, etc. The encoded information can be read by using a scanner with an excitation lamp which excites a Black Fluorescent (BF) ink and causes a strong signal that can be read in an “ON”” mode of an UV lamp automatically by a scanner.

The main use of this concept can be in postage meters or addressing machines by creating a secret key, such as in the destination address, by interlacing characters with BF ink in predetermined locations. The key can point (link) to an independent data base that has the rest of the information as well as the last update. A scanner on the postage meter can read the embedded key information, lookup instructions or process the embedded ones, and then take appropriate action such as applying postage and/or postal Value Added Services for example.

The invention can be used in a IBIP bar code, POSTNET barcode, etc. in order to encode secret keys, information about the origin of the piece, payments, etc. Another embodiment can be in the use of intelligent mail by embedding the POSTNET in the Planet code and embedding information in each code separately.

The use of this key can be for one time use and real time refreshing as well, or to pointing to a data base by assigning a unique code to the message. The processes used can be in, for example: storing/retrieving, payments, instructions for mail processing, services, etc. The information included can be, for example,: class of mail, mailer number, batch number.

The U.S. Postal Service (USPS) can use this invention for their intelligent mail as well. The USPS intelligent mail initiative objective is to be able to uniquely identify individual pieces and unit loads. For different types of mail, the Postal Service will use different bar code symbologies because of differences in mailer needs and in equipment used to process the mail. For letters and flats the Postal Service currently uses POSTNET codes for routing and Planet code for identification. These are numeric codes with combinations of five tall and short bars representing different numbers. The USPS is looking at alternative codes including 2D bar codes and 4 state bar codes used in other countries as a means to combine sorting and identification into a single code.

In one embodiment, the present invention can be used to provide operational codes. In this scenario, the destination address can be used as the secret key repository after meter instruction encoding is determined. The base text for the encoding can read characters and wrap around to the next line (and each line thereafter) forming a continuous sequence of characters or tokens.

For Example, the destination address:

Mike Swenson

35 Waterview Drive

Shelton Conn. 06484

becomes:

Mike Swenson 35 Waterview Drive Shelton Conn. 06484

Now that there is a string of tokens, one can apply a set of operation codes to them. In our example case, we have a three part operation code, Postage Class, Value Added Service, and a variable length code for service specific data. In this simple example of an encoding scheme we use 3 bits (or tokens) for postage class. We will use 4 bits (or tokens) for Value Added Service, and the rest for the variable data required by the service or class of postage (as required). A simple table can be used to decode the scheme. For example:

| Postage Class - | 1st class (001) |
|---|---|
| Value Added Service - | eCertified (0110) |
| Variable destination zip | 06484 (00001100101010100) |

And our operation is the following binary number: 001011000001100101010100

To encode/decode, one can squeeze out spaces: MikeSwenson35WaterviewDriveSheltonConn.06484. And the token string with operation looks like this (bold used to symbolize fluorescent alphanumeric characters):

MikeSwenson35WaterviewDriveSheltonConn.06484

The alphanumeric characters which can be luminesced are “k”, “S”, “w”, “3”, “5”, “t”, “r” and “w”. Expanded back for envelope view:

Mike Swenson

35WaterviewDrive

SheltonConn.06484

A person can create content for the letter (or other object). They can then use a desktop computer and printer with a software plug-in for their address program (such as a software plug-in for MS Word), such as a Pitney Bowes plug-in for creating an envelope, and a luminescent ink cartridge for their printer. Alternatively, the printing and software for printing could be in a separate device, such as a dedicated mailer, rather than a desktop computer. The software could comprise a number of check boxes and services for the user to select. The user selects the features they want to use, inserts an envelope and prints the envelope. The software can calculate which characters will be luminescent, such as fluorescent, and tell the plain ink cartridge and the luminescent ink cartridge to print respective predetermined ones of the characters.

The addressed envelope can then be put in the user's outbox. When the addressed envelope arrives in the mail room, the addressed envelope looks like every other addressed envelope there, and it is fed into a properly equipped postage meter. The meter can have a scanner and can read which characters are excited and which are not (i.e., which characters are printed with plain ink and which characters are printed with luminescent ink). The meter can then decode the instructions or secret key stored in the characters printed with the luminescent ink. The postage meter can then automatically set the appropriate setting, such as postage class, postage value and other services requested for example. The meter can then print the postage meter indicia 18 on the envelope.

One of the features of the present invention is that an increased information density can be provided using differing inks that are not obviously present to a casual observer, but which do not require major changes to a bar code reader.

As noted above, the information of the second information contained in the second section 34 could comprise identification of Postage Class, a Value Added Service, and/or a variable length code for service specific data. These are only examples of information which might be contained in the second information. Any suitable type of information could be provided. Referring also to FIG. 7, a block diagram showing steps used to print the indicium 12 are shown. As indicated by block 40 the first information (the destination address for the example shown in FIG. 3) is input or selected to be printed as the mail piece indicium 12. As indicated by block 42, the second information is selected to be printed as part of the mail piece indicium 12. As indicated by block 44, the controller 22 is adapted or programmed to determine which portion(s) of the mail piece indicium will be printed as the first section 32 of the first information with the first ink 28 and which portion(s) of the mail piece indicium will be printed with the second ink 30 as the second information and as a second section 34. For example, the controller could comprise a look-up table. The second section could also be printed with multiple levels of data similar to that described in U.S. patent application Ser. No. 10/862,220, filed Jun. 7, 2004 which is hereby incorporated by reference in its entirety.

The invention can be used with Multi-ink Metameric Codes for Optimal Information. Metamerism is the property where two objects with different spectra produce in the same visual effect. The human-visual system (HVS) sees color through a set of three filters. Any images whose spectra produce the same three signals through these three filters produce the same signal in the HVS. The spectrum of an image depends on the illuminating spectrum. Reflection spectra that are metameric under one lighting source can be distinguished under a different lighting source. Therefore, metamerism should be referred to a particular illumination. An example is black pigment ink and black dye-based ink. The dye-based ink generally has higher reflectance in the red and infrared. In the following, metameric inks refer to two or more inks that appear the same under normal daylight or room illumination. Inks can also differ in their luminescent spectrum. The term luminescence includes phosphorescence and fluorescence. The definition of metameric used here includes inks that differ in luminescence such as a non-luminescent ink and a luminescent ink with the same apparent color under normal lighting. An example is black ink and black fluorescent ink.

Encoding in a metameric image can be, for example, used in a multi-level barcode encoding scheme. A metameric encoded image hides information using a set of metameric inks. The metamerism is detected using a set of sensors with different spectral characteristics that respond differently to the different metameric inks. There is a range of possible encoding schemes. A naive scheme simply uses two (or N) metameric inks and encodes information using any standard two-level (or N-level) barcode such as PostNet, DataMatrix or PDF417. In the two-level case, one ink is used for the normally black portions and a second metameric ink is used for the normally white areas. In the N-level case, ink n is used to encode level n, where n ε {1, 2 . . . N}.

A more sophisticated approach would encode information in linear combinations of multiple metameric inks. Consider an image with N metameric inks. There is a relationship f(σ₁, σ₂, . . . σ_{N})=c describing the combinations of densities of inks that produce the same visual effect, where σ₁ is the surface density of ink i. In a simple case this relationship is approximately linear, with a vector of weights wⁱ so that the metameric combinations satisfy Σᵢwⁱσᵢ=c. The weights and surface densities are all positive. Information can be encoded in an image in the combination of σ₁'s used to reach c.

It is desirable to allow c to be a predetermined function c(x, y) of position in the image, so that the image as seen in the HVS is recognizable. Define s₁(x, y)=wⁱσ₁(x, y)/c(x, y). The set s₁(x, y) defines a direction independent of c(x, y) in the space spanned by the metameric inks at each point in the image. The sum over the inks satisfies Σᵢsᵢ=1. The naive encoding scheme represents each level by a different ink, that is, simply set sₙ=1 for the n that corresponds to the encoded information level, and sⱼ=0 for the n≠j. A more complex and higher density encoding can be achieved for two inks by selecting the value s₁ in {0, 1/M, 2/M, . . . (M−1)/M, 1} and setting s₂=1−s₁. Now M values can be encoded. For more than two inks, the number of combinations can be increased. For example with three inks and M=3 there are nine combinations of the three s's: (1 0 0) and two permutations, and (2/3, 1/3, 0) and 5 permutations. For 4 metameric inks and M=3 there are 20 combinations so each position can encode over 4 bits. The data can be arranged in a pattern like a barcode.

Continuous watermark encoding can be provided. The phase space watermark is an example of a quasi-continuous grayscale watermark created by adding a linear combination of wavepackets based on some data to an image. A disadvantage of the phase space watermark is that when the image is examined closely, the wavy noise can be seen. The watermark tends to degrade the image quality. Employing two metameric inks allows an improved watermark. Represent the image c(x, y)=c(x, y)·(s₁(x, y)+s₂(x, y)). If the watermark is δ(x, y) then set s₁(x, y)=0.5+δ(x, y) and s₂(x, y)=0.5−δ(x, y). The HVS sees c(x, y), while a detector designed to see the difference between ink 1 and ink 2 sees a signal proportional to δ(x, y).

Instructions are provided to the printing device 20 (see FIG. 2), such as a mailing machine or postage meter, which include encode instructions as a way to provide instructions for accomplishing the steps outlined in FIG. 7. These encode instructions can be provided by any suitable means including a direct user input at the mailing machine, or a network link to a user's computer where information is input, or a memory of information selected by any suitable system for example. In one type of embodiment, when a user creates an address with use of a personal computer word processing program, such as address marking 12 shown in FIG. 12 for example, the personal computer can comprise a software program or link (or the mailing machine could comprise the software program or link) to perform the steps noted in FIG. 7. In alternate embodiments, any suitable system for inputting and/or selecting the first and second information and/or encode instructions could be provided.

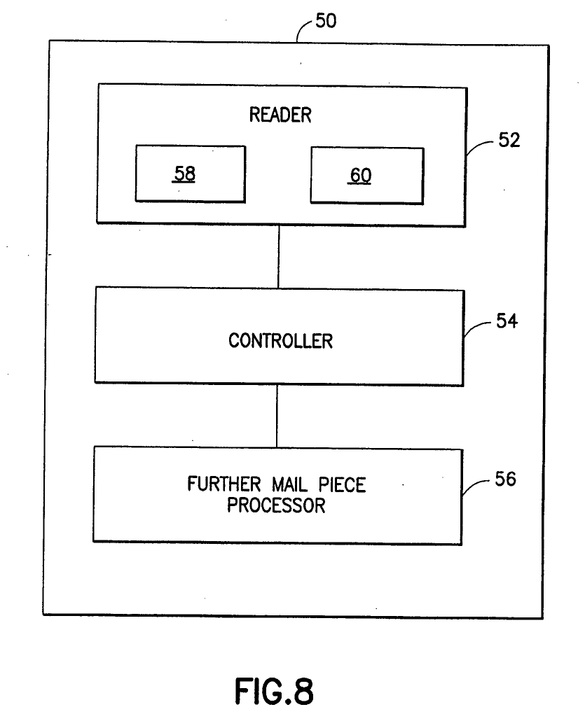

After the mail piece indicium is printed or applied to the mail piece substrate or label, the mail piece can be further processed. Referring also to FIG. 8, a device 50 is shown which is adapted to further process the mail piece. The device 50 could be at least a part of the device 20 shown in FIG. 2. However, in this embodiment, the device 50 is a separate device from the device 20. The device 50 generally comprises a reader 52, a controller 54, and at least one further mail piece processor 56. The device 50 could comprise additional features.

The reader 52 generally comprises an excitation source 58 and a scanner 60. The mail piece can be passed by the excitation source 58 and exposed to an energy source, such as UV light for example, to excite the ink of the second section 34. The scanner 60 is adapted to read the image produced by the luminescent second section 34. A corresponding signal is sent from the reader 52 to the controller 54. The controller is adapted to send a signal to the further processor 56 based upon the signal received from the reader 52 and programming or a data base of the controller. The further processor can include, for example, a postage meter which can print the postage indicium 18 on the mail piece 10 or a label to be applied to the mail piece. The value of the postage indicium 18 could be at least partially selected based upon the information of the second information in the second section 34. For example, if the second information contains postage class information, the postage indicium 18 would be selected based upon the postage class information contained in the second section 34.

The further processing could comprise additional or alternate further processing of the mail piece. For example, if the second information contained a value added service, such as email tracking notification or certified mail for example, the further processor 56 could print additional information on the mail piece substrate or attach a label or tag to the mail piece substrate 11. These are only some examples, any suitable further automatic processing based upon the second information stored in the mail piece indicium could be provided. The mail piece could have multiple mail piece indicia with stored second information as well as their first information.

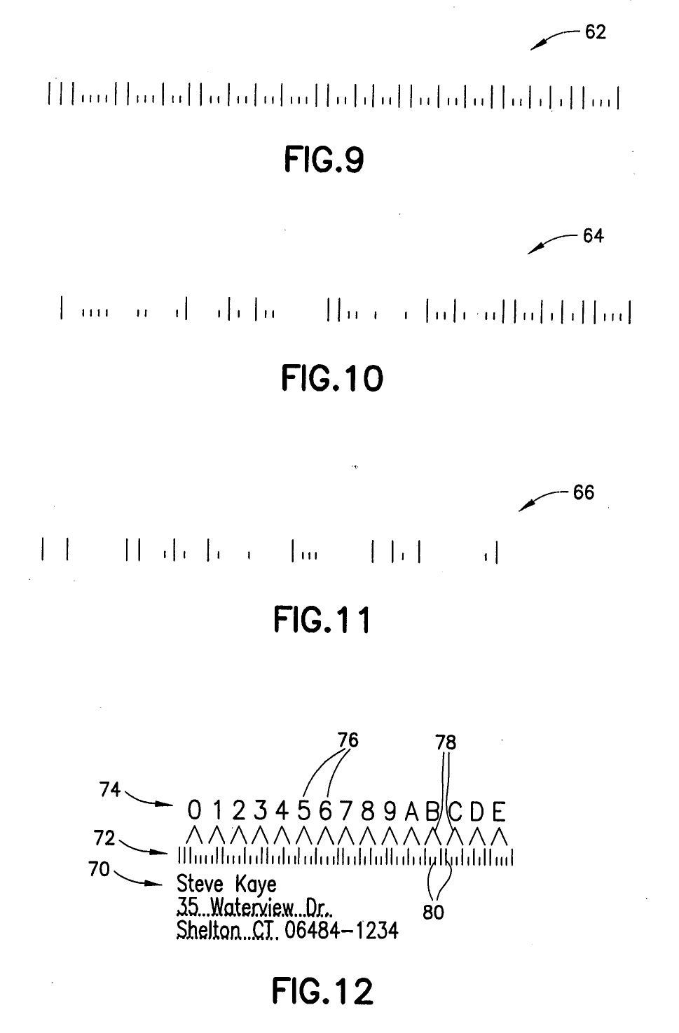

Referring now to FIGS. 9-11, another embodiment of the present invention is shown. FIG. 9 shows a mail piece indicium 62 which comprises a bar code, such as a PostNet or Planet bar code for example. The bar code comprises bars or modules. The bars in this embodiment are printed with the two inks 28, 30 as two different sections 64, 66 as shown in FIGS. 10 and 11. The first section 64 is printed with non-luminescent ink and the second section 66 is printed with luminescent ink. In an alternate embodiment, both inks could be luminescent, but excitable at different wavelength frequencies.

Similar to the embodiment described above in FIGS. 3-5, the first and second sections 64, 66 can be read together to convey the first information. In addition, the second section 66 can read separate from the first section 64, such as by exposing the indicium 62 to UV light, to allow second information to be read from the indicium 62. The selection of which of the bars or pixels of the bars should be printed with the second ink 30 can be determined by the controller 22 based upon the input of the user into the device 20. For example, postage class, value added services, etc. as noted above. In the embodiment shown in FIGS. 9-11, bars 2, 4, 5, 6, 7, 10, 11, 15, 16, 19, 20, 21, 23, 24, 25, 30, 31, 32, 33, 35, 38, 40, 41, 42, 43, 44 and 47-62 are printed with the first ink and bars 1, 3, 8, 9, 12, 13, 14, 17, 18, 22, 26, 27, 28, 29, 34, 36, 37, 39, 45 and 46 are printed with the second ink. In this embodiment, it does not matter than the bars are long or short to convey the second information, just merely that they are in the first ink or the second ink. However, in an alternate embodiment, the type of bar (long or short) could also be used as a component to convey the second information.

Referring now to FIG. 12, there is shown an example of a destination 70 address for a mail piece with a delivery point bar code 72 shown in normal daylight. The delivery point bar code 72 would comprise use of multiple inks similar to the bar code shown in FIG. 9 in order to provide additional information symbolized by data 74 which can be extracted from the multi-ink indicium 72. Each component 76 of the data 74 can be extracted from respective groups 78 of the bars 80 of the bar code. In alternate embodiments, any suitable type of organization of symbology for additional data placement in an indicium could be used.

FIG. 12 is an example of a simple Dual Ink Interlaced Encoding scheme in a PostNet barcode. It uses a simple 4 bit binary code to encode 16 different values. There is room for 15 of these hexadecimal digits in a delivery point PostNet code.

It should be understood that the foregoing description is only illustrative of the invention. Various alternatives and modifications can be devised by those skilled in the art without departing from the invention. Accordingly, the present invention is intended to embrace all such alternatives, modifications and variances which fall within the scope of the appended claims.

What is claimed is:

1. A mail piece marking for a mail piece, the marking comprising:
a first section printed with a first ink; and
a second section printed with a second different ink,
wherein the first and second sections comprise a substantially same color in normal daylight, wherein the first and second sections are intermixed such that combined reading of the first and second sections conveys a first mail piece marking information, and wherein the second ink is adapted to be machine readable to read a second different mail piece marking information contained in the second section.

2. A mail piece marking as in claim 1 wherein the first section comprises alphanumeric characters and the second section comprises alphanumeric characters in a mailing address which combine to form the first mail piece marking information.

3. A mail piece marking as in claim 1 wherein the first section comprises bar code modules and the second section comprises bar code modules in a mail piece bar code which combine to form the first mail piece marking information.

4. A mail piece marking as in claim 1 wherein the first section comprises first pixels in the marking and the second section comprises second pixels in the marking which combine to form the first mail piece marking information.

5. A mail piece marking as in claim 1 wherein the second ink comprises luminescent ink.

6. A mail piece marking as in claim 5 wherein the second ink comprises fluorescent ink.

7. A mail piece marking as in claim 1 wherein the first information comprises mail piece routing information and the second information comprises mail piece tracking information.

8. A mail piece marking as in claim 1 wherein the second information comprises postage class information separate from postage indicium on the mail piece or subsequently applied to the mail piece.

9. A mail piece marking as in claim 1 wherein the second information comprises postal service value added service information.

10. A mail piece marking as in claim 1 wherein the second information comprises a variable length code.

11. A mail piece marking as in claim 1 wherein the second information comprises a secret key for subsequent use in processing the mail piece.

12. A mail piece marking as in claim 11 wherein the secret key comprises a key for subsequent processing of the mail piece by a postage meter.

13. A system for processing a mail piece comprising:
a printer adapted to print a mail piece marking on the mail piece, wherein the printer is adapted to print the marking with a first section printed with a first ink and a second section printed with a second different ink, and wherein the first and second inks comprise a substantially same color in normal daylight;
a reader adapted to sense the second ink for reading information printed in the second section of the marking with the second ink; and
a controller adapted to further process the mail piece based upon the information in the second section read by the reader.

14. A system for processing a mail piece as in claim 13 wherein the printer is adapted to print the first and second sections as alphanumeric characters in a mailing address.

15. A system for processing a mail piece as in claim 13 wherein the printer is adapted to print the first and second sections as portions of a single postal bar code.

16. A system for processing a mail piece as in claim 13 wherein the reader is adapted to read luminescence of the second ink.

17. A system for processing a mail piece as in claim 16 wherein the reader is adapted to read fluorescence of the second ink.

18. A system for processing a mail piece as in claim 13 wherein the further process comprises applying postage to the mail piece.

19. A system for processing a mail piece as in claim 13 wherein the further process comprises indicating a value added service on the mail piece.

20. A system for printing at least one marking on a mail piece, the system comprising:
a printer adapted to print on the mail piece with at least two different inks; and
a controller adapted to control printing of the at least two inks by the printer on the mail piece, wherein the controller is adapted to print the at least one marking with a first section printed with a first one of the inks and a second section printed with a second different one of the inks, and wherein the first and second inks comprise a substantially same color in normal daylight and are adapted to be differentiated to convey additional information in addition to a normal daylight information conveyance of the at least one marking.

21. A system as in claim 20 wherein the controller is adapted to print the first and second sections of the at least one marking with an encoded format to convey the additional information in an encoded form by an arrangement of the first and/or second sections.

22. A method of processing a mail piece comprising:
printing a mail piece marking on the mail piece, the mail piece marking comprising first information printed in at least two different ink sections, wherein different respective inks of the at least two sections have a substantially same color in normal daylight, and wherein when exposed to an excitation source a second one of the sections printed with a second one of the inks is separately discernable from a first one of the sections printed with the first one of the inks;
reading the second section when exposed to the excitation source to obtain second information contained in the second section; and
performing an action on the mail piece based upon the second information read in the second section.

23. A method as in claim 22 wherein performing an action comprises applying postage to the mail piece based upon the second information read in the second section.

24. A method as in claim 22 wherein performing an action comprises indicating a value added service on the mail piece to be used with the mail piece.
